(19) United States
(12) Patent Application Publication
(10) Pub. No.: US 2009/0169001 A1
(43) Pub. Date: Jul. 2, 2009

(54) System and Method for Encryption and Secure Transmission of Compressed Media

(75) Inventors: James Rodgers Tighe, Frisco, TX (US); Rowan L. McFarland, Carrollton, TX (US); Mark T. Nelson, Plano, TX (US)

Correspondence Address: BAKER BOTTS L.L.P., 2001 ROSS AVENUE, SUITE 600, DALLAS, TX, 75201-2980, US

(73) Assignee: CISCO TECHNOLOGY, INC.

(21) Appl. No.: 11/966,247

(22) Filed: Dec. 28, 2007

(51) Int. Cl. H04N 7/167; H04L 9/00

(52) U.S. Cl. 380/217; 713/165

(57) ABSTRACT

A method comprises receiving a bit sequence associated with at least one file, the bit sequence comprising payload data in a compressed format and characterization data that maps the compressed format of the payload data. The method continues by encrypting the characterization data that maps the compressed format of the payload data. The method concludes by transmitting the bit sequence such that the characterization data is encrypted and at least a portion of the payload data is unencrypted.

### TECHNICAL FIELD

This present disclosure relates generally to encryption systems and more particularly to a system and method for encryption of compressed media.

### BACKGROUND

Electronic documents, images, and audio files generally comprise large amounts of data. Traditional techniques for securely transmitting such files over a network often require more time and/or processing resources than are available in typical computer systems.

### BRIEF DESCRIPTION OF THE DRAWINGS

FIG. 1 illustrates a computer system, according to certain embodiments;

FIG. 2 illustrates the encryption of a bit sequence associated with an encoded image file, according to certain embodiments;

FIG. 3 illustrates the encryption of a bit sequence associated with an encoded audio file, according to certain embodiments; and

FIG. 4 illustrates a flowchart for encrypting and transmitting a file over a network, according to certain embodiments.

### DESCRIPTION OF EXAMPLE EMBODIMENTS

Overview

In one embodiment, a method comprises receiving a bit sequence associated with at least one file, the bit sequence comprising payload data in a compressed format and characterization data that maps the compressed format of the payload data. The method continues by encrypting the characterization data that maps the compressed format of the payload data. The method concludes by transmitting the bit sequence such that the characterization data is encrypted and at least a portion of the payload data is unencrypted.

Various embodiments described herein may have none, some, or all of the following advantages. One advantage is that a computer system may efficiently provide encryption of compressed files. In particular, the computer system is operable to encode a particular file as one or more bit sequences. Each bit sequence may comprise characterization data and payload data. The characterization data may map the payload data to a respective portion of the particular file. In some embodiments, the computer system may encrypt the characterization data without encrypting the entire bit sequence. Encrypting the characterization data while allowing the payload data in the bit sequence to remain unencrypted may be faster and use less processing power than encrypting the entire bit sequence.

Another advantage is that the encrypted bit sequence may be securely transmitted over a network. In conjunction with encrypting the characterization data. the computer system may rearrange the segments of payload data in the bit sequence without encrypting the data within each segment. Because the characterization data may serve as a code table for mapping the payload data in the bit sequence to portions of the particular file, a node that intercepts the bit sequence cannot generate or read the particular file as long as the characterization data remains encrypted. Thus, the file may be encrypted efficiently and transmitted securely. Other advantages may be apparent to one skilled in the art from the description and the appended claims.

Description

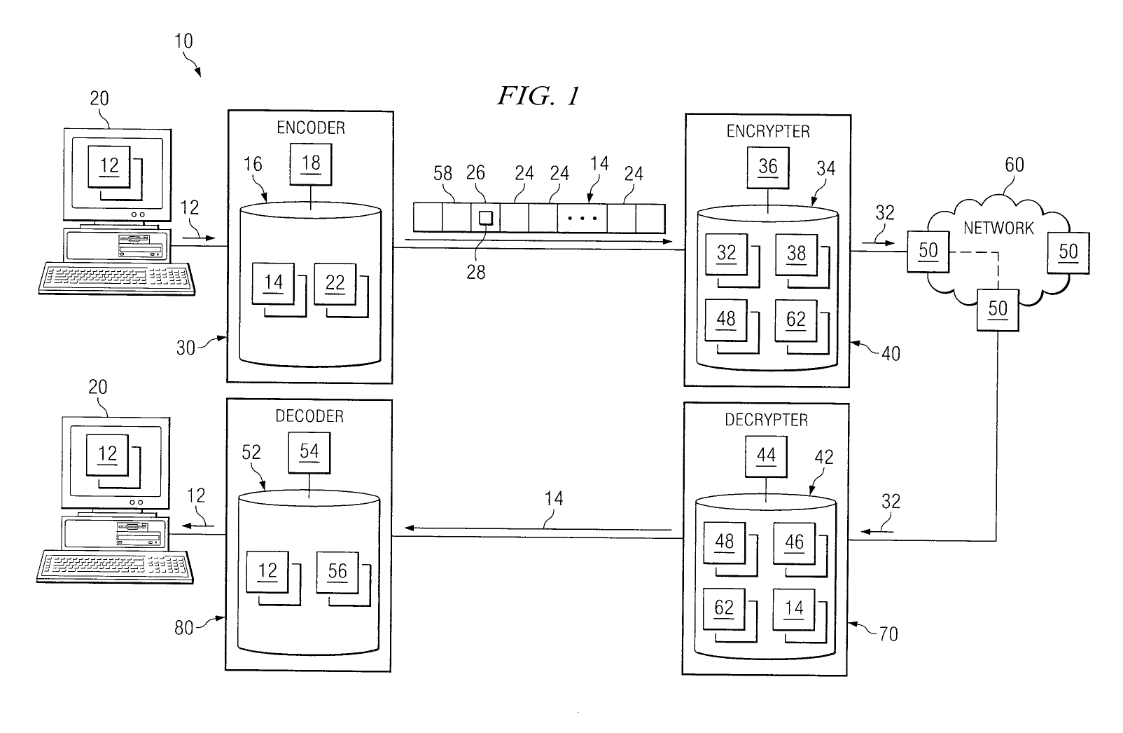

FIG. 1 illustrates a computer system 10, according to certain embodiments. System 10 is generally operable to store, encode, encrypt, and transmit files 12 over one or more networks 60. System 10 may comprise one or more clients 20, an encoder 30, an encrypter 40, one or more routers 50, one or more networks 60, a decrypter 70, and a decoder 80.

Client 20 represents any suitable local or remote end-user device that may access one or more elements of system 10. Client 20 may capture, record, receive, and/or store one or more files 12. File 12 refers to a collection of information that may be stored in system 10. File 12 may be a text file, image, photograph, audio file, spreadsheet, slide show, word processing document, video, and/or any suitable type and combination of file 12. Client 20 may receive, record, and/or capture file 12 via any suitable interface module. In some embodiments, a user may use a keyboard or mouse to input data (e.g., text) that is configured as a document file 12. In other embodiments, client 20 comprises a camera that records video, audio, and/or image files 12. In yet other embodiments, client 20 may receive and/or download files 12 from a server and/or other node of system 10. According to certain embodiments, client 20 may be part of a video/audio conferencing system. Client 20 may comprise a computer, workstation, telephone, Internet browser, electronic notebook, Personal Digital Assistant (PDA), camera, pager, and/or any other suitable device (wireless, wireline, or otherwise), component, or element capable of receiving, processing, storing, and/or communicating information with other components of system 10. Client 20 may also comprise any suitable user interface such as a display, microphone, keyboard, webcam, camera, or any other appropriate terminal equipment according to particular configurations and arrangements. It will be understood that system 10 may comprise any number and combination of clients 20.

System 10 may comprise an encoder 30 that receives and encodes files 12 from client 20. Encoding may refer to the conversion and/or compression of file 12 into bit sequences 14 that conform to a particular digital format. In some embodiments, encoding file 12 refers to exploiting the statistical redundancy of data in order to represent the data in file 12 more concisely. Encoder 30 is operable to encode file 12 according to any suitable file format such as, for example, the ZIP, GNU ZIP, Portable Networks Graphics (PNG), Lempel-Ziv (LZ). Graphics Interchange Format (GIF), Unix pack (.Z), bzip2, PAQ, JPEG, MPEG, MP3, True Audio (TTA), Vorbis, and/or any suitable format. To encode file 12, encoder 30 may execute any suitable compression algorithm such as, for example, the DEFLATE algorithm, Lempel-Ziv-Oberhumer (LZO) algorithm, Burrows-Wheeler Transform (BWT), Dynamic Markov Compression (DMC) algorithm, and/or any suitable lossy and/or lossless data compression algorithm. In some embodiments, encoding may comprise re-encoding file 12 from a particular digital format into another digital format. In other embodiments, encoding may comprise converting file 12 from an analog format to a digital format.

Encoder 30 may comprise any suitable hardware and/or software to provide the described functions and/or operations. In some embodiments, encoder 30 may represent a general-purpose personal computer (PC), a laptop, a Macintosh, a workstation, a Unix-based computer, a server computer, or any suitable processing device. In certain embodiments, encoder 30 may be part of client 20.

Encoder 30 may comprise encoder memory 16 and encoder processor 18. Encoder memory 16 may comprise any suitable arrangement of random access memory (RAM), read only memory (ROM), magnetic computer disk, CD-ROM, or other magnetic or optical storage media, or any other volatile or non-volatile memory devices that store one or more lists, tables, or other arrangements of information. In some embodiments, encoder memory 16 may store bit sequences 14 and encoder logic 22. Encoder logic 22 generally comprises rules, algorithms, code, tables, and/or other suitable instructions for encoding file 12 from client 20.

Encoder memory 16 may be communicatively coupled to encoder processor 18. Encoder processor 18 is generally operable to execute encoder logic 22 to encode and/or convert file 12 into one or more bit sequences 14. Encoder processor 18 may comprise any suitable combination of hardware and software implemented in one or more modules to provide the described functions and/or operations.

As explained above, encoder 30 may output bit sequences 14. A particular bit sequence 14 may be transported in a shared or dedicated communication link according to a statistical multiplexing protocol, time division multiplexing protocol, frequency division multiplexing protocol, and/or any suitable protocol. In some embodiments, each bit sequence 14 corresponds to at least a portion of file 12. Encoder 30 may package a particular bit sequence 14 as a Real-Time Protocol (RTP) packet. Bit sequence 14 for a particular file 12 may comprise one or more headers and a plurality of segments 24. Each segment 24 comprises payload data for a respective portion of file 12. For example, segment 24 of bit sequence 14 for an image file 12 may comprise chrominance and/or luminance data for a block of pixels (e.g., block of 8×8 pixels, 16×16 pixels, and/or any suitable number of pixels) associated with the image. As another example, segment 24 of bit sequence 14 for a document file 12 may comprise data regarding symbols and/or characters in a particular portion of the document. As another example, if bit sequence 14 is associated with an audio file 12 such as, for example, a song, each segment 24 may correspond to a respective frequency band of the song.

In some embodiments, each bit sequence 14 may further comprise characterization data 26. Characterization data 26 in a particular bit sequence 14 generally describes the compression of payload data in the particular bit sequence 14. Characterization data 26 may be an index, map, table, or other suitable information that decoder 80 may use to decompress the data in an encoded bit sequence 14 into a decompressed file format. In some embodiments, characterization data 26 may comprise a code table 28 that maps each segment 24 in bit sequence 14 to a respective portion of file 12 associated with bit sequence 14. Code table 28 may be a Huffman table, adaptive Huffman table, arithmetic code table, quantization table, index, map, code tree, matrix, and/or other suitable table for decoding segments 24 in bit sequence 14. System 10 may use characterization data 26 to decode bit sequence 14 and to map particular segments 24 to particular portions of file 12. For example, if file 12 comprises an image, then characterization data 26 may map each segment 24 in bit sequence 14 to a respective location in the image. As another example, if file 12 comprises a song, then characterization data 26 may map each segment 24 in bit sequence 14 to a respective frequency band and/or time domain of the song. Thus, system 10 may use characterization data 26 to reconstitute the particular file 12 in a decompressed format. In some embodiments, characterization data 26 may be in a header or other suitable location in bit sequence 14.

Encoder 30 may transmit bit sequence 14 to encrypter 40. Encrypter 40 is generally operable to encrypt at least a portion of bit sequence 14. In particular, encrypter 40 may encrypt characterization data 26 in bit sequence 14 associated with file 12. In some embodiments, encrypter 40 may rearrange the sequence of segments 24 in bit sequence 14. Once characterization data 26 has been encrypted, bit sequence 14 may be referred to as encrypted bit sequence 32. Encrypter 40 may output at least one encrypted bit sequence 32 for each file 12 received from client 20.

Encrypter 40 may comprise any suitable hardware and/or software to provide the described functions and/or operations. In some embodiments, encrypter 40 may represent a general-purpose personal computer (PC), a laptop, a Macintosh, a workstation, a Unix-based computer, a server computer, or any suitable processing device. In some embodiments, encrypter 40 is part of router 50. In other embodiments, encrypter 40 and/or encoder 30 are part of client 20.

Encrypter 40 may comprise encrypter memory 34 and encrypter processor 36. Encrypter memory 34 may comprise any suitable arrangement of random access memory (RAM), read only memory (ROM), magnetic computer disk, CD-ROM, or other magnetic or optical storage media, or any other volatile or non-volatile memory devices that store one or more lists, tables, or other arrangements of information. In some embodiments, encrypter memory 34 may store encrypted bit sequence 32 and encrypter logic 38. Encrypter logic 38 generally comprises rules, algorithms, code, tables, and/or other suitable instructions for encrypting one or more bit sequences 14.

Encrypter memory 34 may be communicatively coupled to encrypter processor 36. Encrypter processor 36 is generally operable to execute encrypter logic 38 to encrypt at least a portion of bit sequence 14. Encrypter processor 36 may comprise any suitable combination of hardware and software implemented in one or more modules to provide the described functions and/or operations.

In some embodiments, encrypter 40 may be communicatively coupled to router 50. Router 50 refers to a network device that is operable to route and/or forward data in one or more networks 60. For example, router 50 may be a switch (e.g., layer three switch, network switch, and/or any suitable component) that routes IP packets in an IP network. In some embodiments, router 50 may interconnect logical subnets of one or more networks 60. Router 50 may determine the destination address of a data packet, determine an appropriate network path for the data packet, and/or forward the data packet along the determined network path. In some embodiments, router 50 may comprise a control plane, a forwarding plane, and/or one or more routing tables. A routing table may comprise a list of destination addresses and/or interfaces associated therewith. Router 50 may represent a provider edge router, subscriber edge router, inter-provider router, core router, residential gateway, enterprise router, and/or any suitable network device for routing data in network 60. Router 50 may comprise a processor, memory, and/or any suitable hardware and/or software for performing the described functions and operations.

Router 50 may be communicatively coupled to one or more networks 60. Network 60 may represent any number and combination of wireline and/or wireless networks suitable for data transmission. Network 60 may, for example, communicate internet protocol packets, frame relay frames, asynchronous transfer mode cells, and/or other suitable information between network addresses. Network 60 may include one or more intranets, local area networks, metropolitan area networks, wide area networks, cellular networks, all or a portion of the Internet, and/or any other communication system or systems at one or more locations. Network 60 may comprise any suitable number and combination of routers 50.

One or more routers 50 associated with network 60 may be communicatively coupled to decrypter 70. Decrypter 70 is generally operable to decrypt at least a portion of encrypted bit sequence 32. In particular, decrypter 70 may decrypt characterization data 26. In some embodiments, decrypter 70 may unscramble the sequence of segments 24 in encrypted bit sequence 32. Decrypter 70 may output and transmit bit sequence 14 to decoder 80.

Decrypter 70 may comprise any suitable hardware and/or software to provide the described functions and/or operations. In some embodiments, decrypter 70 may represent a general-purpose personal computer (PC), a laptop, a Macintosh, a workstation, a Unix-based computer, a server computer, or any suitable processing device. In some embodiments, decrypter 70 may be part of a given router 50 associated with network 60. In other embodiments, decrypter 70 and/or decoder 80 may be part of client 20.

Decrypter 70 may comprise decrypter memory 42 and decrypter processor 44. Decrypter memory 42 may comprise any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information. In some embodiments, decrypter memory 42 may store bit sequence 14 and decrypter logic 46. Decrypter logic 46 generally comprises rules, algorithms, code, tables, and/or other suitable instructions for decrypting one or more encrypted bit sequences 32.

Decrypter memory 42 may be communicatively coupled to decrypter processor 44. Decrypter processor 44 is generally operable to execute decrypter logic 46 to decrypt at least a portion of encrypted bit sequence 32. Decrypter processor 44 may comprise any suitable combination of hardware and software implemented in one or more modules to provide the described functions and/or operations.

In some embodiments, decrypter memory 42 and/or encrypter memory 34 may store one or more cryptographic keys 48. Cryptographic key 48 may represent parameters, numbers, and/or other information that may be input into a cryptographic algorithm. In some embodiments, cryptographic key 48 may control data transformation associated with the encryption and/or decryption of data. Cryptographic key 48 may be configured for a symmetric key algorithm, asymmetric key algorithm, digital signature scheme, and/or any suitable cryptographic technique. In some embodiments, cryptographic key 48 may be randomly generated. In other embodiments, cryptographic key 48 may be based at least in part on a password from a user. A password from a user may represent a shared secret that is exchanged between encrypter 40 and decrypter 70 prior to the transmission of one or more encrypted bit sequences 32 over network 60. To encrypt/decrypt bit sequence 14, encrypter 40 and/or decrypter 70 may execute an algorithm that conforms to the Digital Encryption Standard (DES), Advanced Encryption Standard (AES), Triple Data Encryption Standard (Triple DES), and/or any suitable type and/or combination of cryptographic algorithms.

Decrypter 70 may transmit bit sequence 14 to decoder 80, which is generally operable to decode bit sequence 14. For a particular file 12, decoding may comprise decompressing bit sequence 14 into at least a portion of file 12 (e.g., image, song, document, etc.). Decoder 80 may decompress bit sequence 14 based at least in part on entropy decompression, pixel prediction, inloop deblocking, frequency transform, and/or any number and combination of suitable decompression techniques. In some embodiments, decoding comprises mapping particular segments 24 from bit sequence 14 to particular portions of file 12 based at least in part on characterization data 26. As explained above, characterization data 26 may comprise code table 28 that maps each segment 24 of payload data to a respective portion of file 12. For example, characterization data 26 may map tone and/or volume data from a particular segment 24 of bit sequence 14 to a particular frequency band and/or time slot of an audio file 12. As another example, characterization data 26 may map chrominance and/or luminance data from a particular segment 24 of bit sequence 14 to a particular location of a photograph in an image file 12. As yet another example, characterization data 26 may map font and/or symbol data from a particular segment 24 of bit sequence 14 to a particular section of a document file 12.

Decoder 80 may comprise any suitable hardware and/or software to provide the described functions and/or operations. In some embodiments, decoder 80 may represent a general-purpose personal computer (PC), a laptop, a Macintosh, a workstation, a Unix-based computer, a server computer, or any suitable processing device.

Decoder 80 may comprise decoder memory 52 and decoder processor 54. Decoder memory 52 may comprise any suitable arrangement of random access memory (RAM), read only memory (ROM), magnetic computer disk, CD-ROM, or other magnetic or optical storage media, or any other volatile or non-volatile memory devices that store one or more lists, tables, or other arrangements of information. In some embodiments, decoder memory 52 may store files 12 and decoder logic 56. Decoder logic 56 generally comprises rules, algorithms, code, tables, and/or other suitable instructions for decoding one or more bit sequences 14.

Decoder memory 52 may be communicatively coupled to decoder processor 54. Decoder processor 54 is generally operable to execute decoder logic 56 to decode bit sequence 14 to a file format that may be received, stored, displayed, executed, and/or played by client 20. Decoder processor 54 may comprise any suitable combination of hardware and software implemented in one or more modules to provide the described functions and/or operations.

It should be understood that the internal structure of system 10 and the servers, processors, and memory devices associated therewith is malleable and can be readily changed, modified, rearranged, or reconfigured to achieve the intended operations of system 10. It should be further understood that particular components of system 10 may be combined or separated in any suitable manner according to the desired configuration of system 10.

In operation, client 20 receives, identifies, records, and/or captures file 12. In some embodiments, file 12 may be retrieved from memory of client 20. In other embodiments, file 12 may be received from a user via an interface module of client 20. In yet other embodiments, file 12 may be downloaded from a server or other node in system 10.

Client 20 may transmit file 12 to encoder 30, which may encode file 12 into a suitable compressed format such as, for example, ZIP, GNU ZIP, Portable Networks Graphics (PNG), Lempel-Ziv (LZ), Graphics Interchange Format (GIF), Unix pack (.Z), bzip2, PAQ, JPEG, MPEG, MP3, True Audio (TTA), Vorbis, and/or any suitable format. For a particular file 12, encoder 30 may output at least one bit sequence 14 that comprises characterization data 26 and a plurality of segments 24. Encoding file 12 may comprise generating code table 28 that maps each segment 24 in bit sequence 14 to a respective portion of file 12 associated with bit sequence 14. Code table 28 may be comprised in characterization data 26.

Encoder 30 may transmit bit sequence to encrypter 40, which may then encrypt at least a portion of bit sequence 14. In particular, encrypter 40 may encrypt characterization data 26 while one or more segments 24 of payload data in bit sequence 14 remain unencrypted. In some embodiments, encrypter 40 may rearrange the order of segments 24 of payload data in bit sequence 14. Encrypter 40 may then transmit encrypted bit sequence 32 to router 50.

Router 50 may forward encrypted bit sequence 32 over network 60 to the appropriate router 50 associated with decrypter 70. In some embodiments, because portions of encrypted bit sequence 32 were not encrypted, router 50 may read and/or determine the appropriate destination address of encrypted bit sequence 32 without having to decrypt all or portions of encrypted bit sequence 32.

Decrypter 70 may receive and decrypt encrypted bit sequence 32 from network 60. In particular, decrypter 70 may decipher and/or convert characterization data 26 to its original format. Decrypter 70 may further unscramble the order of segments 24 in encrypted bit sequence 32. Decrypter 70 may transmit bit sequence 14 to decoder 80, which may decompress bit sequence 14 into at least a portion of file 12. Using the decrypted characterization data 26, decoder 80 may map segments 24 from bit sequence 14 to the appropriate portions of file 12 associated with bit sequence 14. Decoder 80 may output and transmit file 12 to client 20, which may display, play, and/or otherwise present file 12 to a user.

In some embodiments, system 10 may provide various advantages. Various embodiments of system 10 may have none, some, or all of the following advantages. One advantage is that system 10 may encrypt and securely transmit files 12 over network 60. In particular, for a particular bit sequence 14, system 10 may encrypt characterization data 26 without encrypting the entire bit sequence 14. For example, the data in each segment 24 may remain unencrypted. Because the data within each segment 24 remains unencrypted, encrypting and decrypting bit sequence 14 in system 10 may be faster and require less processing resources than encrypting and decrypting an entire bit sequence 14. Because characterization data 26 maps segments 24 to file 12, decoder 80 cannot generate file 12 from bit sequence 14 as long as characterization data 26 remains encrypted. Thus, file 12 may be encrypted efficiently and kept secure from unauthorized users.

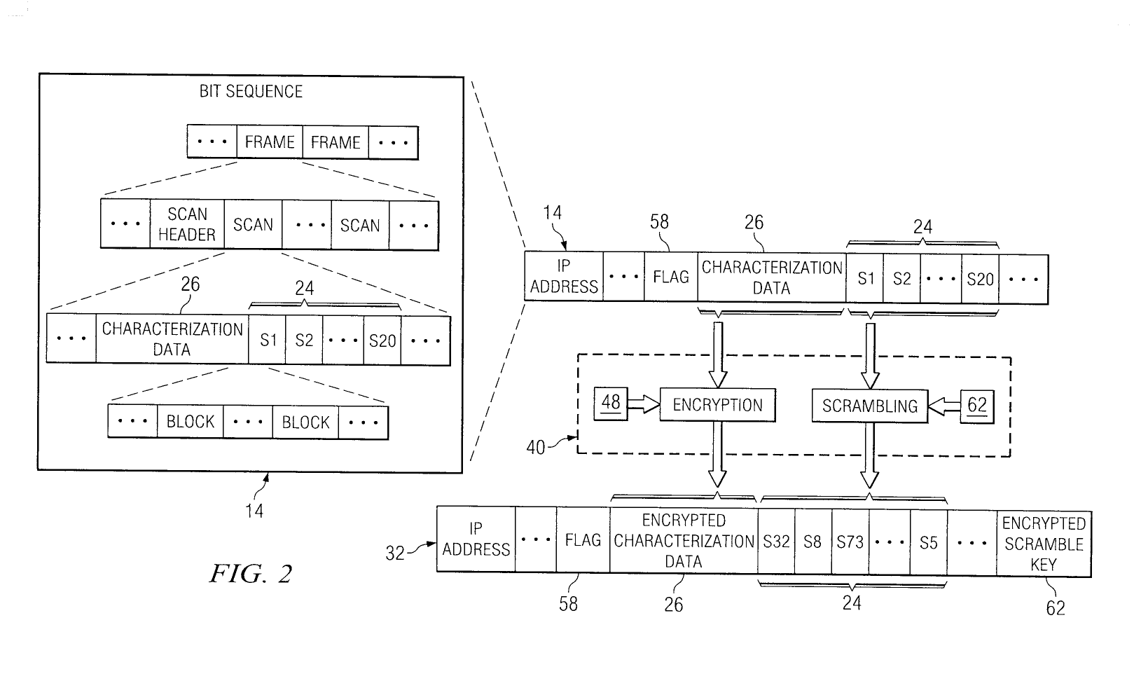

As explained above, bit sequence 14 may be encoded according to any suitable format. FIG. 2 illustrates the encryption of bit sequence 14 associated with an encoded image, according to certain embodiments. Such bit sequence 14 may be referred to as an image bit sequence 14. Image file 12 associated with image bit sequence 14 may be encoded according to any suitable format such as, for example, JPEG, GIF, TIFF, PNG, and/or any suitable format. Encoder 30 may employ lossy or lossless compression to encode file 12 as an image.

To encode file 12 for a particular image as an image bit sequence 14, encoder 30 may convert the particular image from the RGB (“Red, Green, Blue”) color space into the YCbCr color space. In the YCbCr color space, the Y component may refer to the brightness of a pixel, the Cb component may refer to the blue chrominance component, and the Cr component may refer to the red chrominance component. In other embodiments, encoder 30 may convert the image from the RGB color space into an sRGB color space in which each color plane is compressed and quantized separately.

Once the color space of the image is converted, encoder 30 may downsample file 12. Downsampling, which may be referred to as chroma subsampling, may comprise reducing the Cb and Cr components according to any suitable ratio (e.g., 4:2:2 or 4:2:0). Once encoder 30 downsamples the image file 12, encoder 30 may split each data channel associated with the particular image into blocks of pixels. A particular block may comprise any suitable number of pixels. For example, a block may be an 8×8 block of pixels, 16×16 block of pixels, and/or any suitable number of pixels.

In some embodiments, in conjunction with splitting the data channels associated with file 12 into blocks, encoder 30 may convert each component (e.g., Y, Cb, and Cr) of each block into a frequency-domain representation using a normalized discrete cosine transform (DCT). Encoder 30 may then quantize the data associated with each block. In particular, encoder 30 may reduce the amount of information in file 12 that is associated with high frequency brightness variation. In conjunction with quantizing the particular image associated with file 12, encoder 30 may apply entropy coding to the particular image. Entropy coding may comprise generating one or more code tables 28. Code table 28 may be a Huffman table, arithmetic table, map, index, matrix and/or other suitable table associated with the data in file 12. In some embodiments, code table 28 associated with an image bit sequence 14 maps the plurality of blocks in the image bit sequence 14 to respective portions of the particular image associated with bit sequence 14. Thus, decoder 80 may use code table 28 in characterization data 26 to decompress bit sequence 14 and/or regenerate the image associated with bit sequence 14. Once encoder 30 completes the entropy coding, encoder 30 may output bit sequence 14.

Bit sequence 14 may represent a compressed form of the data from file 12. In some embodiments, an image bit sequence 14 may comprise a plurality of layers. In particular, an image bit sequence 14 may comprise a frame layer that includes at least one frame. A particular frame may comprise a scan header and a plurality of scans. Each scan may be associated with a respective pass through the pixels of the particular image. For example, a first scan may be associated with a pass through the red component of the image, a second scan may be associated with a pass through the blue component of the image, and so forth.

In some embodiments, each scan in bit sequence 14 may comprise characterization data 26 and a plurality of segments 24 of payload data. Each segment 24 may comprise a plurality of blocks. As explained above, a particular block may comprise any suitable number of pixels (e.g., 8×8 block of pixels, 16×16 block of pixels, etc.). Characterization data 26 may map the payload data in each segment 24 to respective portions of the particular image associated with the given frame of bit sequence 14. In some embodiments, characterization data 26 may comprise a segment identifier for each segment 24 in the given scan. For example, a first segment 24 may be identified as “S1”, a second segment 24 may be identified as “S2”, and so forth. The plurality of segments 24 in bit sequence 14 may be arranged in a particular sequence.

In some embodiments, encoder 30 transmits bit sequence 14 to encrypter 40, which may store a cryptographic key 48. Cryptographic key 48 may be a shared secret that is exchanged between encrypter 40 and decrypter 70 prior to the transmission of one or more bit sequences 14 over network 60. In some embodiments, a particular cryptographic key 48 may be hard coded in encrypter 40 and/or decrypter 70. In other embodiments, cryptographic key 48 may be derived from a password input by a user and/or received from any suitable key source. Encoder 30 may input cryptographic key 48 into an encryption algorithm stored in encrypter memory 34 in order to encrypt characterization data 26 in bit sequence 14. Encrypting characterization data 26 may comprise encrypting one or more code tables 28 in characterization data 26. The encryption algorithm may be a symmetric key algorithm, asymmetric key algorithm, DES algorithm, AES algorithm, Triple DES algorithm, and/or any suitable algorithm for encrypting characterization data 26.

Each scan in an image bit sequence 14 may comprise a respective set of characterization data 26. Encoder 30 may encrypt the respective set of characterization data 26 associated with each scan in the image bit sequence 14.

In some embodiments, bit sequence 14 comprises a flag 58 in association with characterization data 26. Flag 58 may be one or more bits that signify the start of characterization data 26 in bit sequence 14. In some embodiments, flag 58 signifies whether characterization data 26 is in an encrypted state. According to certain embodiments, encrypter 40 does not encrypt flag 58. Upon receiving encrypted bit sequence 32 from network 60, decrypter 70 may scan encrypted bit sequence 32 for flag 58 in order to locate the encrypted characterization data 26.

In some embodiments, encrypter memory 34 stores a scramble key 62. Encrypter 40 may use scramble key 62 to rearrange segments 24 in bit sequence 14 into a scrambled sequence. Rearranging segments 24 in bit sequence 14 may comprise changing the order of segments 24 without actually encrypting the bits of data (e.g., chrominance data, luminance data, etc.) in each segment 24. Scramble key 62 may represent a series of numbers, a code, a series of segment identifiers, and/or other suitable information from which the original sequence of segments 24 can be determined. Encrypter 40 may input scramble key 62 into a transform function to determine a scrambled order in which to rearrange segments 24. According to certain embodiments, encrypter 40 rearranges segments 24 into a random or pseudo-random order. In some embodiments, after using scramble key 62 to rearrange the order of segments 24, encrypter 40 encrypts scramble key 62 and transmits the encrypted scramble key 62 with encrypted bit sequence 32. In other embodiments, encrypter 40 transmits the encrypted scramble key 62 separately from encrypted bit sequence 32. According to certain embodiments, scramble key 62 is associated with and/or derived from a password that is exchanged between encrypter 40 and decrypter 70 in conjunction with the transmission of data over network 60.

In some embodiments, although encrypter 40 encrypts characterization data 26, encrypter 40 does not encrypt data in the other portions of bit sequence 14. For example, encrypter 40 may not encrypt the destination address, buffer parameters, and/or other portions of bit sequence 14. According to certain embodiments, although encrypter 40 rearranges the order of segments 24 in each scan in bit sequence 14, encrypter 40 does not encrypt the data in each block of segment 24. By allowing portions of bit sequence 14 to remain unencrypted, encrypter 40 may effectively secure bit sequence 14 while expending less time and processing resources than if the entire bit sequence 14 were encrypted.

Once characterization data 26 is encrypted and the sequence of segments 24 is rearranged, encrypter 40 may transmit encrypted bit sequence 32 to router 50. Because portions of encrypted bit sequence 32 are not encrypted (e.g., destination address, RTP header, etc.), router 50 may determine that encrypted bit sequence 32 comprises image data. Router 50 may further determine the appropriate path along which to forward encrypted bit sequence 32.

Once encrypted bit sequence 32 traverses network 60, decrypter 70 may receive and decrypt encrypted bit sequence 32. In some embodiments, decrypter 70 may use cryptographic key 48 to decipher each characterization data 26 in bit sequence 14. Deciphering characterization data 26 may comprise restoring characterization data 26 to its original form. In conjunction with decrypting characterization data 26, decrypter 70 may use cryptographic key 48 to decipher the encrypted scramble key 62. Decrypter 70 may then input scramble key 62 into a transform function to determine the original sequence of segments 24 in each scan of bit sequence 14. Decrypter 70 may rearrange segments 24 back to their original sequence. Decrypter 70 may output bit sequence 14 to decoder 80, which may decompress bit sequence 14 into file 12. To decode bit sequence 14, decoder 80 may perform the reverse of each encoding step. For example, decoder 80 may combine blocks of pixels and transform the compressed data back to an RGB color space. Decoder 80 may transmit the decompressed image file 12 to client 20, which may display, process, and/or store the image file 12.

As explained above, an image bit sequence 14 may comprise a frame layer, a scan layer, a segment layer, and a block layer. In the example described above, encrypter 40 encrypts characterization data 26 in the segment layer. In other embodiments, encrypter 40 may encrypt one or more scan headers in the scan layer. In yet other embodiments, encrypter 40 may encrypt one or more headers in the frame and/or block layers.

In the foregoing example, encrypter 40 encrypts characterization data 26 in conjunction with scrambling the order of segments 24. In some embodiments, encrypter 40 may effectively secure bit sequence without scrambling the order of segments 24. In particular, encrypter 40 may encrypt characterization data 26 in bit sequence 14 but leave the plurality of segments 24 in their original order.

The foregoing example describes the encryption/decryption of an image bit sequence 14. It should be understood, however, that system 10 is operable to encrypt/decrypt any suitable type of file 12 that is compressed according to any suitable file format such as, or example, the ZIP, GNU ZIP, Portable Networks Graphics (PNG), Lempel-Ziv (LZ), Graphics Interchange Format (GIF), JPEG, Unix pack (.Z), bzip2, PAQ, MPEG, True Audio (TTA), Vorbis, and/or any suitable format. System 10 may encrypt/decrypt any suitable type of encoded bit sequence 14 that comprises characterization data 26 and segments 24 of payload data.

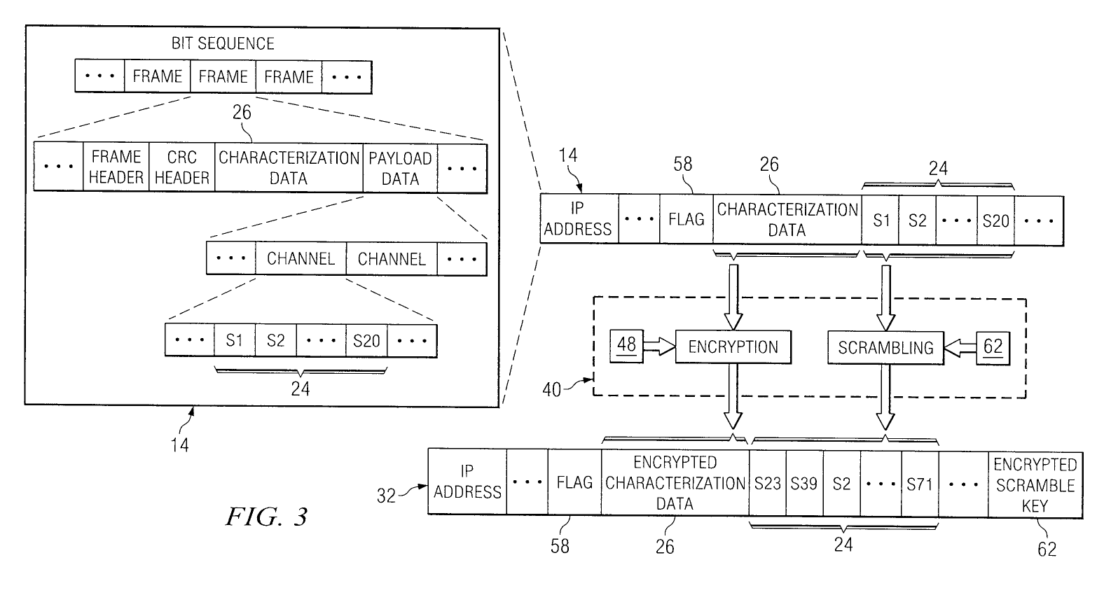

FIG. 3 illustrates the encryption of bit sequence 14 that is associated with an encoded audio file 12, according to certain embodiments. Such bit sequence 14 may be referred to as an audio bit sequence 14. Audio file 12 associated with audio bit sequence 14 may be encoded according to any suitable format such as, for example, MP3 or Vorbis.

To encode an audio file 12, encoder 30 may convert the audio in file 12 into a sequence of pulse-code modulation (PCM) samples that may be filtered into a plurality of frequency sub-bands. Encoder 30 may then divide each frequency sub-band into a plurality of long and/or short windows. In conjunction with dividing each frequency sub-band into windows, encoder 30 may apply a modified discrete cosine transform (MDCT) to each window of each frequency sub-band.

In some embodiments, encoder 30 may input an audio signal associated with file 12 into one or more algorithms that model human sound perception. Encoder 30 may thereby determine which parts of the audio signal are not within the normal range of human hearing. Encoder 30 may filter out one or more components of the audio signal that are not within the normal range of human hearing. Encoder 30 may then quantize and/or code the portions of the audio signal that remain. Coding the audio signal may comprise generating one or more code tables 28 (e.g., Huffman tables, modified Huffman tables, arithmetic tables, etc.), which may be transmitted in characterization data 26 of bit sequence 14.

In some embodiments, an audio bit sequence 14 for a particular file 12 may comprise a plurality of layers. A first layer may comprise one or more frames. Each frame may store multiple (e.g., 576, 1152, etc.) audio samples and may cover a particular time interval (e.g., 26 milliseconds) of the particular file 12. A particular frame may comprise a frame header, cyclic redundancy check (CRC) header, characterization data 26, and payload data.

The frame header for a particular frame may comprise a synchronization key and/or a description of the particular frame. The CRC header may comprise checksum data that a receiver may use to check for transmission errors.

The payload data may comprise the compressed audio data associated with the audio file 12. In some embodiments, the payload data comprises a channel layer and a segment layer. Each channel may correspond to a respective frequency range of the audio file 12. In some embodiments, a particular channel comprises one or more segments 24. Each segment 24 may comprise volume data, frequency data, tone data, and/or other suitable data for a respective portion of the audio file 12.

According to certain embodiments, characterization data 26 comprises one or more code tables 28 that map the respective segments 24 in each channel of bit sequence 14 to the appropriate portions (e.g., frequencies, time slots, etc.) of audio file 12. In some embodiments, characterization data 26 may comprise a segment identifier for each segment 24 in bit sequence 14. For example, a first segment 24 may be identified as “S1”, a second segment 24 may be identified as “S2”, and so forth. The plurality of segments 24 in bit sequence 14 may be arranged in a particular sequence.

In some embodiments, encoder 30 transmits bit sequence 14 to encrypter 40. Encoder 30 may input cryptographic key 48 into an encryption algorithm stored in encrypter memory 34 in order to encrypt characterization data 26 in bit sequence 14. Encrypting characterization data 26 may comprise encrypting one or more code tables 28 in characterization data 26. The encryption algorithm may be a symmetric key algorithm, asymmetric key algorithm, DES algorithm, AES algorithm, Triple DES algorithm, and/or any suitable algorithm for encrypting characterization data 26.

In conjunction with encrypting characterization data 26, encrypter 40 may use scramble key 62 from encrypter memory to rearrange segments 24 in bit sequence 14 into a scrambled order. Rearranging segments 24 in bit sequence 14 may comprise changing the order of segments 24 without actually encrypting the bits of data (e.g., frequency data, tone data, etc.) in each segment 24. Encrypter 40 may input scramble key 62 into a transform function to determine a scrambled order in which to rearrange segments 24. In some embodiments, after using scramble key 62 to rearrange the order of segments 24, encoder 30 encrypts scramble key 62 and transmits the encrypted scramble key 62 with encrypted bit sequence 32.

In some embodiments, although encrypter 40 encrypts characterization data 26, encrypter 40 does not encrypt data in the other portions of an audio bit sequence 14. For example, encrypter 40 may not encrypt the destination address, buffer parameters, and/or other portions of bit sequence 14. According to certain embodiments, although encrypter 40 rearranges the sequence of segments 24 in bit sequence 14, encrypter 40 does not encrypt the data in each segment 24. By allowing portions of an audio bit sequence 14 to remain unencrypted, encrypter 40 may effectively secure bit sequence 14 while expending less time and processing resources than if the entire bit sequence 14 were encrypted.

Once characterization data 26 is encrypted and the sequence of segments 24 is rearranged, encrypter 40 may transmit encrypted bit sequence 32 to router 50. Because portions of encrypted bit sequence 32 are not encrypted (e.g., destination address, RTP header, etc.), router 50 may determine that encrypted bit sequence 32 comprises audio data. Router 50 may further determine the appropriate path along which to forward encrypted bit sequence 32.

Once encrypted bit sequence 32 traverses network 60, decrypter 70 may receive and decrypt encrypted bit sequence 32. In some embodiments, decrypter 70 may use cryptographic key 48 to decipher characterization data 26 in bit sequence 14. Deciphering characterization data 26 may comprise restoring characterization data 26 to its original form. In conjunction with decrypting characterization data 26, decrypter 70 may use cryptographic key 48 to decipher the encrypted scramble key 62. Decrypter 70 may then input scramble key 62 into a transform function to determine the original order of segments 24 in each channel of bit sequence 14. Decrypter 70 may rearrange segments 24 back to their original order. Decrypter 70 may output bit sequence 14 to decoder 80, which may decompress bit sequence 14 into an audio file 12, which may be played, processed, and/or stored by client 20.

In the foregoing example, encrypter 40 encrypts characterization data 26 in conjunction with scrambling the sequence of segments 24. In some embodiments, encrypter 40 may effectively secure bit sequence without scrambling the sequence of segments 24. In particular, encrypter 40 may encrypt characterization data 26 in bit sequence 14 but leave the plurality of segments 24 in their original order.

The foregoing example illustrates an audio bit sequence 14. In some embodiments, a particular bit sequence 14 may be associated with a text file 12. Such bit sequence 14 may be referred to as a text bit sequence 14. A text bit sequence 14 may be encoded according to any suitable format such as, for example, ZIP, gzip, LZMA, DGCA, LHA, and/or any suitable format.

In some embodiments, a text bit sequence 14 may comprise a plurality of segments 24. Each segment 24 may comprise a local file header, file data (e.g., payload data), and a data descriptor. In some embodiments, the size of each segment 24 may be defined by a user. The values associated with a text bit sequence 14 may be stored in little-endian byte order. In some embodiments, a text bit sequence 14 may comprise a central directory after the plurality of segments 24. The central directory may allow a processor to locate and extract particular portions of a text file 12 without having to scan each header associated with the text file 12. A text file 12 may be encoded according to any suitable compression algorithm such as, for example, the Lempel-Ziv-Markov chain algorithm (LZMA), the Lempel-Ziv-Welch algorithm (LZW), the LZ77 algorithm, Shannon-Fano coding, Huffman coding, and/or any suitable algorithm.

In some embodiments, a text file 12 may be encoded according to the DEFLATE algorithm to generate a text bit sequence 14. In such embodiments, the text bit sequence 14 may comprise compressed payload data that is arranged as a series of segments 24 corresponding to successive blocks of input data from the text file 12. Each segment 24 may be compressed according to a combination of the LZ77 algorithm and Huffman coding. Compressing each block of the text file 12 may comprise generating a respective Huffman tree for each block of data from the text file 12. A Huffman tree is an example of characterization data 26. The respective Huffman trees for each segment 24 may be independent of each other. In some embodiments, the LZ77 algorithm may use a reference to a duplicated string occurring in a previous segment 24 of payload data.

In some embodiments, each segment 24 in a text bit sequence 14 may comprise (1) a pair of Huffman trees that describe the representation of compressed payload data in the particular segment 24 and (2) the compressed payload data. In some embodiments, the Huffman trees themselves may be compressed using Huffman encoding. The compressed payload data may comprise (1) literal bytes of strings that have not been detected as duplicated within a predetermined number of previous input bytes and (2) pointers to duplicate strings. In some embodiments, encrypter 40 may encrypt a text bit sequence 14 by encrypting the pair of Huffman trees in each segment 24 while the compressed payload data in each segment 24 remains unencrypted.

The foregoing examples describe the encryption/decryption of an image bit sequence 14, an audio bit sequence 14, and a text bit sequence 14, respectively. It should be understood, however, that system 10 is operable to encrypt/decrypt any suitable type of file 12 that is compressed according to any suitable file format such as, or example, the ZIP, GNU ZIP, Portable Networks Graphics (PNG), Lempel-Ziv (LZ), Graphics Interchange Format (GIF), Unix pack (.Z), bzip2, PAQ, MPEG, True Audio (TTA), Vorbis, MP3 and/or any suitable format. System 10 may encrypt/decrypt any suitable type of encoded bit sequence 14 that comprises characterization data 26 and segments 24 of payload data. By encrypting characterization data 26 while leaving the payload data in an unencrypted format, system 10 may encrypt bit sequence efficiently and transmit bit sequence 14 securely.

The foregoing example illustrates the transmission of encrypted bit sequence 32 over network 60. In some embodiments, however, encrypter 40 may communicate with decrypter 70 without network 60. For example, encrypter 40 and decrypter 70 may be communicatively coupled in a device or system. In such embodiments, encrypter 40 may transmit encrypted bit sequence 32 to decrypter 70 without network 60.

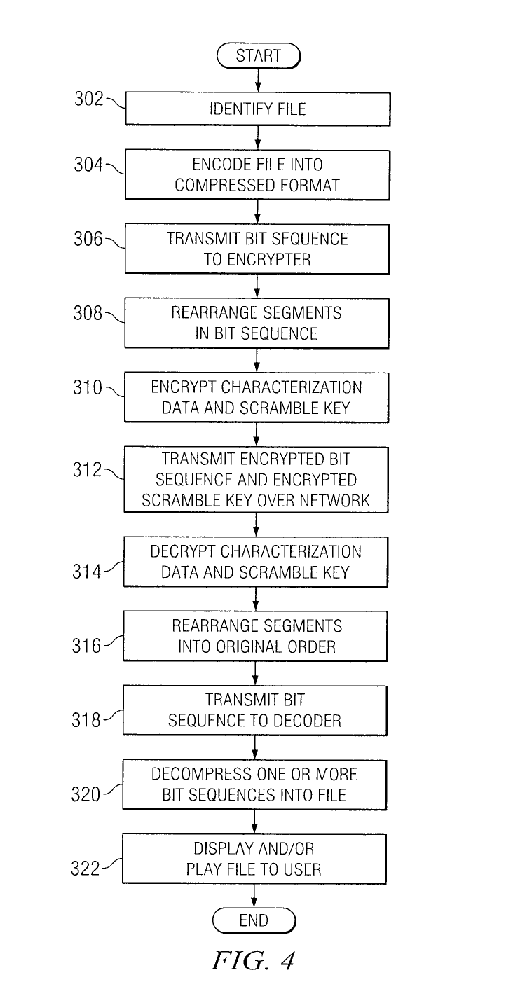

FIG. 4 illustrates a flowchart for encrypting and transmitting file 12 over network 60, according to certain embodiments. The method begins at step 302 where a first client 20 identifies file 12 stored in memory associated with client 20. At step 304, encoder 30 receives and encodes file 12 into a compressed format. Encoding file 12 may comprise generating one or more bit sequences 14. Bit sequence 14 may comprise characterization data 26 and a plurality of segments 24. In some embodiments, characterization data 26 may comprise code table 28 that correlates each segment 24 to a particular portion of file 12.

At step 306, encoder 30 transmits bit sequence 14 to encrypter 40. At step 308, encrypter 40 rearranges segments 24 in bit sequence 14 into a scrambled order. Encrypter 40 may determine the scrambled order by inputting scramble key 62 into a transform function. At step 310, encrypter 40 encrypts characterization data 26 in bit sequence 14 as well as scramble key 62. At step 312, encrypter 40 transmits encrypted bit sequence 32 and the encrypted scramble key 62 over network 60 to decrypter 70.

At step 314, decrypter 70 decrypts characterization data 26 and scramble key 62. Encoder 30 and decoder 80 may perform the encryption/decryption using any suitable cryptographic algorithm and/or cryptographic key 48. At step 316, decrypter 70 inputs the decrypted scramble key 62 into a transform function to determine the original order of segments 24 in bit sequence 14. Decrypter 70 may rearrange segments 24 into their original order. At step 318, decrypter 70 transmits bit sequence 14 to decoder 80. At step 320, decoder 80 decompresses one or more bit sequences 14 into file 12. Decoder 80 may decompress bit sequence 14 based at least in part on entropy decompression, pixel prediction, inloop deblocking, frequency transform, and/or any number and combination of suitable decoding techniques. At step 322, client 20 plays and/or displays file 12 for a user. The method then ends.

The present disclosure encompasses all changes, substitutions, variations, alterations, and modifications to the example embodiments described herein that a person having ordinary skill in the art would comprehend. Similarly, where appropriate, the appended claims encompass all changes, substitutions, variations, alterations, and modifications to the example embodiments described herein that a person having ordinary skill in the art would comprehend.

What is claimed is:

1. A method, comprising:
receiving a bit sequence associated with at least one file, the bit sequence comprising payload data in a compressed format and characterization data that maps the compressed format of the payload data;
encrypting the characterization data that maps the compressed format of the payload data; and
transmitting the bit sequence such that the characterization data is encrypted and at least a portion of the payload data is unencrypted.

2. The method of claim 1, wherein the bit sequence is compressed according to at least one of the following formats: ZIP, JPEG, JFIF, MPEG, and MP3.

3. The method of claim 1, wherein:
the at least one file is associated with an image that comprises a plurality of pixels;
the bit sequence comprises a plurality of segments of payload data, each segment associated with a respective portion of the plurality of pixels; and
the characterization data maps each segment to a respective portion of the image.

4. The method of claim 3, wherein:
each segment comprises chrominance data in a particular digital format;
the characterization data is encrypted while the chrominance data in the plurality of segments remains in the particular digital format; and
transmitting the bit sequence such that at least a portion of the payload data is unencrypted comprises transmitting the plurality of segments in the particular digital format.

5. The method of claim 1, wherein:
the file is associated with an audio recording that comprises a plurality of frequency bands; and
the bit sequence comprises a plurality of segments of payload data, each segment associated with a respective portion of the plurality of frequency bands.

6. The method of claim 5, wherein:
each segment comprises frequency data in a particular digital format,
the characterization data is encrypted while the frequency data in the plurality of segments remains in the particular digital format; and
transmitting the bit sequence such that at least a portion of the payload data is unencrypted comprises transmitting the plurality of segments in the particular digital format.

7. The method of claim 1, wherein:
the received bit sequence comprises a plurality of segments of payload data;
the plurality of segments in the received bit sequence are arranged in a first order;
and further comprising:
in conjunction with encrypting the at least one segment header, rearranging the plurality of segments into a second order in the bit sequence.

8. The method of claim 7, wherein:
the second order is a pseudo-random order based at least in part on a scramble key; and
rearranging the plurality of segments into the second order comprises ordering the plurality of segments in the bit sequence in accordance with the second order.

9. The method of claim 8, further comprising:
encrypting the scramble key; and
in conjunction with transmitting the bit sequence, transmitting the encrypted scramble key.

10. The method of claim 1, wherein:
the bit sequence is transmitted over a network to a decryption module;
and further comprising:
decrypting the characterization data;
decompressing the bit sequence associated with the at least one file; and
displaying the at least one file.

11. An apparatus, comprising:
a memory operable to store a cryptographic key; and
a processor communicatively coupled to the memory and operable to:
receive a bit sequence associated with at least one file, the bit sequence comprising payload data in a compressed format and characterization data that maps the compressed format of the payload data;
encrypt the characterization data that maps the compressed format of the payload data, the encryption based at least in part on the cryptographic key; and
transmit the bit sequence such that the characterization data is encrypted and at least a portion of the payload data is unencrypted.

12. The apparatus of claim 11, wherein the bit sequence is compressed according to at least one of the following formats: ZIP, JPEG, JFIF, MPEG, and MP3.

13. The apparatus of claim 11, wherein:
the at least one file is associated with an image that comprises a plurality of pixels;
the bit sequence comprises a plurality of segments of payload data, each segment associated with a respective portion of the plurality of pixels; and
the characterization data maps each segment to a respective portion of the image.

14. The apparatus of claim 13, wherein:
each segment comprises chrominance data in a particular digital format;
the characterization data is encrypted while the chrominance data in the plurality of segments remains in the particular digital format; and
transmitting the bit sequence such that at least a portion of the payload data is unencrypted comprises transmitting the plurality of segments in the particular digital format.

15. The apparatus of claim 11, wherein:
the file is associated with an audio recording that comprises a plurality of frequency bands; and
the bit sequence comprises a plurality of segments of payload data, each segment associated with a respective portion of the plurality of frequency bands.

16. The apparatus of claim 15, wherein:
each segment comprises frequency data in a particular digital format;
the characterization data is encrypted while the frequency data in the plurality of segments remains in the particular digital format; and
transmitting the bit sequence such that at least a portion of the payload data is unencrypted comprises transmitting the plurality of segments in the particular digital format.

17. The apparatus of claim 11, wherein:
the received bit sequence comprises a plurality of segments of payload data;
the plurality of segments in the received bit sequence are arranged in a first order; and
in conjunction with encrypting the at least one segment header, the processor is further operable to rearrange the plurality of segments into a second order in the bit sequence.

18. The apparatus of claim 17, wherein:
the second order is a pseudo-random order based at least in part on a scramble key; and
rearranging the plurality of segments into the second order comprises ordering the plurality of segments in the bit sequence in accordance with the second order.

19. The apparatus of claim 18, wherein the processor is further operable to:
encrypt the scramble key; and
in conjunction with transmitting the bit sequence, transmit the encrypted scramble key.

20. An apparatus, comprising:
means for receiving a bit sequence associated with at least one file, the bit sequence comprising payload data in a compressed format and characterization data that maps the compressed format of the payload data;
means for encrypting the characterization data that maps the compressed format of the payload data; and
means for transmitting the bit sequence such that the characterization data is encrypted and at least a portion of the payload data is unencrypted.
